(19) United States
(12) Patent Application Publication
(10) Pub. No.: US 2004/0164457 A1
(43) Pub. Date: Aug. 26, 2004

(54) Method of rotational molding

(76) Inventors: R. Barry Rogers, Saskatoon (CA); Wilfred H. Wilger, Saskatoon (CA); Jason H. Wilger, Saskatoon (CA)

Correspondence Address: ADE & COMPANY, 1700-360 MAIN STREET, WINNIPEG, MB, R3C3Z3, CA

(21) Appl. No.: 10/370,080

(22) Filed: Feb. 21, 2003

(51) Int. Cl. B29C 41/04

(52) U.S. Cl. 264/310

(57) ABSTRACT

A rotational molding method for forming two separate molded parts each including an undercut portion includes providing a mold formed from two mold parts connected at a mold junction, introducing a particulate plastics material and rotating the mold about two axes while applying heat to the mold so as to cause the plastics material to melt within the hollow interior and adhere to the inside surface. An annular heat conduction member extends from an outer edge outside the mold through the junction between the two mold parts to an inner edge inside the hollow interior and carries two undercut mold portions for molding respective undercut portions of the two separate molded parts. A band of a heat insulating material such as Teflon is located around the junction between the parts on the inside of the heat conducting member which prevents the adherence of the plastics material at the band so that the mold molds the separate molded parts each separately from the other. The heat conduction member carries heat from the exterior to the undercut mold portions to ensure proper coating thereof by the plastic as it melts.

The present invention relates to methods of rotational molding.

### BACKGROUND OF THE INVENTION

Rotational molding is a plastic forming method whereby an enclosed metal container, consisting of two or more halves or components bolted or clamped together, is rotated in two directions while be heated to the melting point of the plastic charge. While the mold halves are separated, a specific amount of powered plastic charge, depending on the desired thickness of the end product, is placed in the mold. The mold is closed and clamped together to prevent plastic from leaking out while it is rotated in two directions in a furnace. As it is heated the plastic starts to melt and sticks substantially evenly to the surface of the mold depending on the temperature of the mold surface creating a plastic shape similar to the mold. After all the plastic has melted the mold is cooled causing the plastic to contract and pull away from the surface of the mold.

When partially cooled the mold is opened and a hollow tank like form is removed. This process is excellent for making tanks as the resulting part is a hollow structure similar to a tank. If non hollow parts are desired the tank shape must be cut apart to create the non hollow parts. In current technology the plastic must be able to shrink away from all the mold surfaces must which prevents the incorporation of undercut shapes.

An undercut part or undercut shape as used herein is one which requires a mold element which is located inwardly of the main body of the mold with surfaces which require to be covered by the plastics material which are spaced inwardly from the inner surface of the main body. The mold element may thus define surfaces to be coated including an inner surface facing inwardly of the main body toward the center and an outer surface facing back toward the inner surface of the main body.

### SUMMARY

It is one object of the present invention to provide a method of rotational molding which allows manufacture of a molded part having an undercut.

According to a first aspect of the invention there is provided a method for a forming a part by rotational molding comprising:

providing a mold formed from at least two mold parts and having an inside surface defining a hollow interior;

introducing into the hollow interior a thermoplastic plastics material in particulate form;

rotating the mold about two axes while applying heat to the mold so as to cause the plastics material to melt within the hollow interior and adhere to the inside surface;

when the plastics material is fully melted and adhered to the inside surface, halting the application of heat to allow cooling of the plastics material to at least partial rigidity;

and when the plastics material is cooled to at least partial rigidity, separating the mold parts to open the mold;

wherein the improvement comprises:

providing a heat conduction member extending from an outer end outside the mold to an inner end inside the hollow interior;

providing a mold element carried on the heat conduction member within the mold interior;

and causing the heat conduction member to carry heat from the exterior into the interior of the mold to provide heat to the mold element.

The number of parts of the mold may be more than two in some cases, but preferably and in most cases the mold is made in two equal halves for forming two generally symmetrical plastics components.

Preferably the heat conducting member has a thermal conductivity greater than that of the mold material. For example the mold body may be made of steel and the heat conducting member of aluminium.

Preferably the heat conducting member is located at the junction between the mold parts.

Preferably the heat conducting member is clamped between the mold parts and is removable from both.

Preferably the heat conducting member forms a continuous band around the junction between the mold parts so as to allow use of a mold element which is also annular and arranged around the full periphery of the part to be formed.

Preferably the mold element is shaped and arranged for molding an undercut portion of the molded part.

Preferably the heat conducting member is located at the junction between the mold parts, wherein each mold part is arranged to form a separate molded part which are arranged to be separated each from the other when the mold parts are separated and wherein the heat conduction member carries undercut mold portions for co-operating respectively with each of the separate molded parts.

Preferably there is provided a band around the interior junction between the parts which prevents the adherence of the plastics material at the junction so that the mold molds the separate molded parts each separately from the other.

Preferably the band is located inside the heat conduction member and is carried thereby.

Preferably the band is located inside the undercut mold portions and separates each from the other.

According to a second separate aspect of the invention there is provided a method wherein the improvement comprises providing an insulating member formed of a low heat transfer material at a selected location on the mold, the low heat transfer material being arranged to prevent the adherence of the plastics material to the mold at the selected location.

Preferably the insulating member is located on the inside surface of the mold.

Preferably the insulating member is located at the junction between the mold parts.

Preferably each mold part is arranged to form a separate molded part which are arranged to be separated each from the other when the mold parts are separated and wherein the insulating member forms a band surrounding the junction between the mold parts which prevents the adherence of the plastics material at the junction so that the mold molds the separate molded parts each separately from the other.

According to a third aspect of the invention there is provided a method in which the improvement comprises:

providing an annular heat conduction member extending from an outer edge outside the mold through the junction between the mold parts to an inner edge inside the hollow interior;

providing on the heat conducting member inside the mold undercut mold portions for molding respective undercut portions of two separate molded plastics components;

provided on the heat conducting member a band of a heat insulating material around the junction between the parts which prevents the adherence of the plastics material at the band so that the mold molds the separate molded plastics components each separately from the other;

and causing the heat conduction member to carry heat from the exterior to the undercut mold portions.

This arrangement as described in more detail hereinafter thus provides a technique which can be used to make a non hollow plastic part with an undercut shape in it. A second advantage is that cooling air can circulate around both sides of the two separate molded parts once each is removed from the mold.

As two open pieces, both surfaces of each part cool together, reducing warping. In a hollow part the air can only move around the outside causing it to cool and contract at a greater rate than the inside. Conventionally, cooling of the outside only shrinks it faster forcing the inside to stretch to accommodate the greater contraction of the outside of the part creating warp.

This arrangement described hereinafter produces an undercut molded part in two parts or more in a rotational mold. In the past it has been impossible to mold interior small undercut shapes because the plastic would not flow around the shape and the heat would not move into the inner surface to melt the plastic powder to form the shape.

This arrangement described hereinafter uses metal of higher heat transfer rate to draw heat to the interior of the mold to melt the plastic around the undercut form.

The form is placed at the split line or between the halves of the mold so the plastic can shrink to it from both halves. Most conventional molds are made of the same metal thereby giving even heat transfer through constant thickness of the metal. To mold undercuts on the interior, heat must be transferred through the mold joints to the interior. This is done by using a high heat transfer bar, greater than the mold itself, such as aluminium, clamped between the two steel mold halves effectively into the shape. The shape is machined or formed in such a manner that the hot plastic part will stretch and slip off the interior mold easily with reasonable force.

As set forth in the arrangement described hereinafter, to prevent the plastic from forming around the insert from one half of the mold to the other making it impossible to get the insert out, an insulating material is fastened to the inside insert that prevents the heat from melting plastic in the area between the two or more mold components thus automatically molding two separate non hollow parts. A low heat transfer material, high heat resistant material, such as Teflon, that the plastic does not tend to stick to is required to make the separating ring inside the mold.

### BRIEF DESCRIPTION OF THE DRAWINGS

In the accompanying drawings, which illustrate an exemplary embodiment of the present invention:

FIG. 1 is a vertical cross sectional view through a mold for use in a method according to the present invention.

FIG. 2 is a top plan view of the mold of FIG. 1.

FIG. 3 is a side elevational view of the mold of FIG. 1.

### DETAILED DESCRIPTION

In FIGS. 2 and 3 is shown schematically a rotational molding method which includes a mold 10 mounted within a support frame 11 with the application of heat to the mold from a heating system generally indicated at 12.

One example of the frame is shown in FIG. 2 and acts to support the mold for rotation about two axis including a first rotation Rl and a second rotation R2 about mutually orthogonal axis. For this purpose the frame provides a first mounting component 13 which carries an outer shaft 14 carrying barrings for providing the first rotation R1. The shaft 14 carries an inner frame which surrounds the mold and provides bearings 15 carrying shaft 16 which attaches to the mold at clamping points 17. The frame as shown is only one example and many other arrangements for providing necessary rotation of the mold are well known to one skilled in the art.

The heating system 12 is again shown schematically as an external heating system located underneath the mold for generating heat onto the exterior of the mold. However the heating system may comprise an oven within which the mold is located or other techniques well known to one skilled in the art.

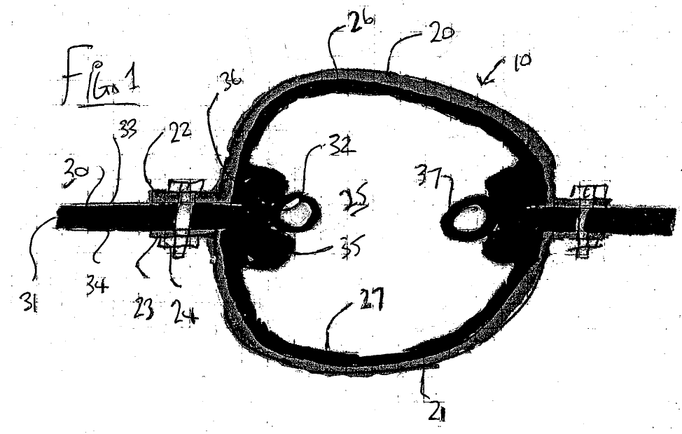

The mold as best shown in FIG. 1 comprises 2 mold halves 20 and 21 which connect together at peripheral flanges 22 and 23 clamped together by bolts 24. The mold parts 21 and 21 thus define a hollow interior 25 and an inside surface 26 of the mold within which the molding action takes place.

Conventionally, a quantity of pellets or particles of a thermoplastic plastics material are introduced into the mold prior to connection of the two parts to form the hollow interior. Thus when connected, the plastics material is wholly contained within the hollow interior and is free to move within the hollow interior. The quantity introduced is dependant upon the intended thickness of the plastics material on the inside surface 26 of the mold.

With the plastics material in place, the mold is rotated in the two directions while the heat is applied so that the mold becomes heated to a temperature sufficient to melt the plastics material which then adheres to the inside surface 26 as the mold rotates to define a layer 27 of the plastics material.

The arrangement shown herein includes, in addition to the conventional mold sections 20 and 21, a heat conducting member 30 in the form of an annular plate having an outer edge 31, an inner edge 32, a top flat surface 33 and a bottom flat surface 34. The dimensions of the annular plate are such that the outer edge 31 is located outwardly of the mold and outwardly of the flanges 32 so as to be exposed beyond the outer edge of the mold to receive heat from the heating system 12. The inner edge 32 is located within the mold that is inside of the surface 26. The heat conduction member is formed of a material having a high thermal conductivity and generally higher than that of the mold elements 20 and 21 so as to more effectively transfer heat and thus carry the heat from the exterior of the mold into the interior of the mold.

At the required location, the heat conducting plate includes holes for receiving the bolts 24 so that the flanges 22 and 23 of the mold parts clamp on respective sides of the plate to hold the plate in fixed position between the two mold parts. However it will be appreciated that removal of the bolts allows the three components defined by the two mold parts and the heat conducting plate.

Inside the mold, the heat conducting plate carries a dog-bone shaped mold element 35. This provides a mold portion projecting outwardly from the side of the plate along the inside of the mold at a position spaced inwardly from the inside surface of the mold. This provides an undercut section 36 of the mold in which it is normally difficult to provide sufficient heat to cause the plastics material to melt onto the undercut section. The manufacturer of the mold element 35 from the high heat transfer material and its attachment to the high heat transfer plate which carries the heat from the exterior to the components within the mold ensures that the mold portions within the outer shell of the mold reach the required temperature to cause the plastics material to melt onto the surface of the mold elements.

The inner edge 32 of the heat transfer or heat conducting plate is covered by a band 37 of a low heat transfer material. In the embodiment shown the band 37 is in the form of a tube which is bent around to form a hoop attached to the inside surface 32. The band 37 is thus in effect an insulating material or material which prevents heat transfer from the heat conducting plate to the outside surface of the band 37 so that the temperature of the surface does not reach the required temperature to melt the plastics material and thus prevents or inhibits the melting of the plastics material and its attachment to the outside surface of the band 37. The band 37 is in the form of a tube so that it is of relatively lightweight with the hollow interior assisting in reducing heat transfer to the outside surface of the band 37. The band must be formed of a material which is resistant to the temperatures required within the mold and Teflon is a suitable material which has low heat transfer characteristics and which can accommodate the require temperatures.

It will be noted that the band 37 covers the inside surface 32 of the heat transfer plate so that it prevents any plastics material covering that inside surface. This divides the plastics material into two separate sections above and below the heat transfer plate respectively.

The “dog-bone ”shape provides a mold element 36 which has a wider portion spaced from the plate 30 and a neck at the plate 30 so that the plastics material when formed wraps around the wider portion into the neck to form a channel with a narrower mouth. The arrangement of the present invention is particularly suitable for forming a molded part of this shape with the narrow neck section wrapped around the wider section of the mold but this is not essential and the mold may simply form a channel in the edge. The neck section of course can be used to receive and trap a bead or edge within the channel since the bead is held in place in the wider part of the molded part and trapped by the neck.

This arrangement is particularly suitable for attachment of a skirt to the bottom edge of the molded section since the skirt can have a wider bead at its upper edge which is inserted into the channel and held in place by the neck.

Thus in operation with the plastics material inserted into the mold, the rotation of the mold in two directions causes the plastics material to tumble within the mold and thus enter all the areas and channels within the mold including the undercut section around the dog-bone mold shape. The plastics material attaches to any surface which is heated to the required temperature so that it attaches to the inside surface of the mold and to the heated mold element within the outer body of the mold due to the high heat transfer from the heat conducting plate. Thus the plastics material provides a layer 27 as shown which covers all of the surfaces. However the presence of the band 37 divides the plastics material into two separate sections which can be released from the separate parts of the mold after the mold is dismantled into the two parts and the heat conducting plate and its mold element remove. The plastics material remains sufficiently soft in the area of the neck to allow the mold element to be pulled out of the neck thus releasing the two separate parts from the mold and allowing those two separate parts to be pulled out of the mold for cooling to the set condition. It is of course necessary therefore, within the knowledge of one skilled in this art, to control the time periods for heating to ensure that the plastics material is properly melted, for cooling in the mold while the mold continues to rotate until the plastics material is sufficiently set to allow the parts to be removed and to remove the mold elements from within the mold on the heat transfer plate without the part becoming sufficiently stiff that the mold elements cannot be removed. Subsequently the molded parts can be left to cool with the cooling effect occurring on both surfaces so as to allow a more symmetrical shrinkage as the parts cool to room temperature.

While the heat conducting member is shown as being annular and around the full periphery of the mold, it is also possible that the heat conducting member can be of limited extent into only a part of the mold. Thus for example the heat conducting member and its mold elements may extend along the front and rear of a generally rectangular mold. For this purpose the mold edges at the flanges can be shaped with a step to receive the two sections of the heat transfer plate and clamp the plate therebetween where required and with the flanges clamping directly together where the plate is omitted.

Such an arrangement is particularly suitable for forming a cover for a sprayer where the front and rear edges of the cover carry depending skirts with a bead at the top edge of the skirt inserted into the channel. One or both ends, extending at right angles to the front and rear edges, may therefore be free of the skirt and thus do not need the molded channel.

The general principles involved in this present invention which are therefore the use of the heat transfer plate to a mold section within the body of the mold and also the use of an insulating or low heat transfer section which prevents the adherence of the plastics material can be used in other arrangements located with a rotational molding mold at any suitable location within the mold and not necessarily just at the junction line as shown herein.

While embodiments of the present invention has been described in the foregoing, it is to be understood that other embodiments are possible within the scope of the invention. The invention is to be considered limited solely by the scope of the appended claims.

1. A method for a forming a part by rotational molding comprising:
providing a mold formed from at least two mold parts and having an inside surface defining a hollow interior;
introducing into the hollow interior a thermoplastic plastics material in particulate form;
rotating the mold about two axes while applying heat to the mold so as to cause the plastics material to melt within the hollow interior and adhere to the inside surface;
when the plastics material is fully melted and adhered to the inside surface, halting the application of heat to allow cooling of the plastics material to at least partial rigidity;
and when the plastics material is cooled to at least partial rigidity, separating the mold parts to open the mold;
wherein the improvement comprises:
providing a heat conduction member extending from an outer end outside the mold to an inner end inside the hollow interior;
providing a mold element carried on the heat conduction member within the mold interior;
and causing the heat conduction member to carry heat from the exterior into the interior of the mold to provide heat to the mold element.

2. The method according to claim 1 wherein the heat conducting member has a thermal conductivity greater than that of the mold.

3. The method according to claim 1 wherein the heat conducting member is located at a junction between the mold parts.

4. The method according to claim 3 wherein the heat conducting member is clamped between the mold parts.

5. The method according to claim 3 wherein the heat conducting member forms a continuous band around the junction between the mold parts.

6. The method according to claim 1 wherein the mold element is shaped and arranged for molding an undercut portion of the molded part.

7. The method according to claim 6 wherein the heat conducting member is located at a junction between the mold parts, wherein each mold part is arranged to form a separate molded plastics component which components are arranged to be separated each from the other when the mold parts are separated and wherein the heat conducting member carries undercut mold portions for co-operating respectively with each of the separate molded plastics components.

8. The method according to claim 7 wherein there is provided a band around the junction between the mold parts which prevents the adherence of the plastics material at the junction so that the mold forms the separate molded plastics components each separately from the other.

9. The method according to claim 8 wherein the band is located inside the heat conducting member and is carried thereby.

10. The method according to claim 8 wherein the band is located inside the undercut mold portions and separates each from the other.

11. A method for a forming a part by rotational molding comprising:
providing a mold formed from at least two mold parts and having an inside surface defining a hollow interior;
introducing into the hollow interior a thermoplastic plastics material in particulate form;
rotating the mold about two axes while applying heat to the mold so as to cause the plastics material to melt within the hollow interior and adhere to the inside surface;
when the plastics material is fully melted and adhered to the inside surface, halting the application of heat to allow cooling of the plastics material to at least partial rigidity;
and when the plastics material is cooled to at least partial rigidity, separating the mold parts to open the mold;
wherein the improvement comprises providing an insulating member formed of a low heat transfer material at a selected location on the mold, the low heat transfer material being arranged to prevent the adherence of the plastics material to the mold at the selected location.

12. The method according to claim 11 wherein the insulating member is located on the inside surface of the mold.

13. The method according to claim 11 wherein the insulating member is located at the junction between the mold parts.

14. The method according to claim 11 wherein each mold part is arranged to form a separate molded plastics component which components are arranged to be separated each from the other when the mold parts are separated and wherein the insulating member forms a band surrounding the junction between the mold parts which prevents the adherence of the plastics material at the junction so that the mold molds the separate molded plastics components each separately from the other.

15. The method according to claim 11 wherein the insulating member is tubular.

16. The method according to claim 11 wherein the insulating member is formed from Teflon.

17. A method for a forming two separate molded parts each including an undercut portion by rotational molding comprising:
providing a mold formed from at least two mold parts and having an inside surface defining a hollow interior;
introducing into the hollow interior a thermoplastic plastics material in particulate form;
rotating the mold about two axes while applying heat to the mold so as to cause the plastics material to melt within the hollow interior and adhere to the inside surface;
when the plastics material is fully melted and adhered to the inside surface, halting the application of heat to allow cooling of the plastics material to at least partial rigidity;
and when the plastics material is cooled to at least partial rigidity, separating the mold parts to open the mold;
wherein the improvement comprises:
providing an annular heat conduction member extending from an outer edge outside the mold through the junction between the mold parts to an inner edge inside the hollow interior;
providing on the heat conducting member inside the mold undercut mold portions for molding respective undercut portions of two separate molded plastics components;
provided on the heat conducting member a band of a heat insulating material around the junction between the parts which prevents the adherence of the plastics material at the band so that the mold molds the separate molded plastics components each separately from the other;
and causing the heat conduction member to carry heat from the exterior to the undercut mold portions.

18. The method according to claim 17 wherein the heat conducting member has a thermal conductivity greater than that of the mold.

19. The method according to claim 17 wherein the heat conducting member is clamped between the mold parts.
